(19) United States
(12) Patent Application Publication
(10) Pub. No.: US 2016/0225246 A1
(43) Pub. Date: Aug. 4, 2016

(54) POWER APPARATUS WITH OUTLET IDENTIFICATION CAPABILITY AND OUTLET IDENTIFICATION METHOD OF POWER APPARATUS

(71) Applicant: CYBER POWER SYSTEMS, INC., TAIPEI CITY (TW)

(72) Inventors: LING-YING HUANG, TAIPEI CITY (TW); HUNG-CHUN CHIEN, TAIPEI CITY (TW); YUNG-HAO PENG, TAIPEI CITY (TW)

(73) Assignee: CYBER POWER SYSTEMS, INC., TAIPEI CITY (TW)

(21) Appl. No.: 15/003,166

(22) Filed: Jan. 21, 2016

(30) Foreign Application Priority Data
Feb. 4, 2015 (TW) 104103690

(51) Int. Cl. G08B 21/18; H01R 13/717; H01R 24/76; H01R 25/00

(52) U.S. Cl. CPC G08B 21/18; H01R 25/006; H01R 13/7175; H01R 24/76

(57) ABSTRACT

A Power apparatus with outlet identification capability and outlet identification method of power apparatus, the outlet identification method uses an identification requirement to enable a power apparatus can identify a plug-in position of at least one powered device, the identification requirement has an internet protocol address and an outlet code of at least one powered device; the power apparatus includes a power distribution equipment, the power distribution equipment has a plurality of outlets, when the power distribution equipment receives an identification requirement, at least one indicator light can be driven to radiate according to the identification requirement, or at least one PDE display can be driven to show a outlet code of the identification requirement.

### BACKGROUND OF THE INVENTION

1. Field of the Invention

The invention relates to a power apparatus with outlet identification capability and a outlet identification method of power apparatus, the apparatus and method use at least one IP (internet protocol) address and at least one outlet code to enable a PDE (power distribution equipment) to proceed the outlet identification, therefore can identify a plug-in position of at least one powered device.

2. Description of Related Art

U.S. Pat. No. 8,723,653 entitled “Asset identification and management method and system” disclosed the system has a PDU (power distribution unit), the PDU includes a reader, an optional antenna switch, a plurality of antennas, a power supply and a plurality of electrical outlets; each asset needs a transponder and RFID tag, so as to proceed the identification. The above prior-art needs higher apparatus costs, in particular, as far as a server room having more devices needs much more transponders and RFID tags. Thus, there is a requirement of improvement for the above prior-art.

Moreover, cable distribution of server room is complicated, and it will be not easy to identify, the server room must continuously supply power to devices (e.g., server), and the server room can not break off the power; the electrical outlets did not provide for an indication function in the above prior-art, a repairman can not easy to find out the corrected position of the electrical outlets if any device needs to make a replacement, a repair or a test; maybe the repairman imprudently break off the power of other devices, and the imprudence could cause a unexpected result.

### SUMMARY OF THE INVENTION

It is therefore an object of the invention to provide a power apparatus with outlet identification capability comprising at least one PDE (power distribution equipment), the PDE has a plurality of outlets, when the PDE receives an identification requirement, the PDE can driver at least one indicator light to radiate according to the identification requirement, or driver at least one PDE display to show a outlet code according to the identification requirement.

It is therefore another object of the invention to provide an outlet identification method of power apparatus, the method use an identification requirement to enable a PDE to identify a plug-in position of at least one powered device, the method comprising a step 1, setting a plurality of identification datum, each identification data has an IP (internet protocol) address and a plurality of outlet codes; a step 2, performing an outlet identification function of a manager, the manager has a user interface, a plurality of PDEs and the manager can be connected to become a network; a step 3, the manager transmits a network packet, the network packet has an identification requirement, the identification requirement has at least one IP address and at least one outlet code; a step 4, at least one PDE has an IP address which is conformed to the IP address of identification requirement, and the conformed PDE can perform an indication function according to the outlet code of identification requirement, therefore can identify a plug-in position of a powered device.

First advantages of the invention is, user does not need to inquire about an IP address and an outlet code of each powered device, and user can quickly find out a correct plug-in position of at least one powered device, therefore can make a replacement, a repair or a test for the powered device, and prevent to imprudently break off the power of other devices, in particular, the invention can be suitable for a server room, which particularly is a server room having more powered devices and complicated cable.

Second advantages of the invention is, a user interface of the invention is easy to operate, user can click any executing key of the user interface to transform a data to an identification requirement, and transmit the identification requirement to a plurality of PDEs by a network packet manner. Moreover, user can select a data or a plurality of datum, and after that user can click a confirming key of the user interface to transform the selected data (or datum) to an identification requirement, and transmit the identification requirement to a plurality of PDEs by a network packet manner.

Third advantages of the invention is, the user interface has an indication function adjustment option, such as a color adjustment option, a flash switch adjustment option or a flash frequency adjustment option. Thus, user can quickly adjust a radiation mode of an outlet indicator light or a display mode of a PDE display.

Fourth advantages of the invention is, the user interface has a device matrix, each device of the device matrix has at least one corresponding description area to point out a plug-in position of each device, when a cursor is moved to a device of the device matrix, the user interface can display a description area. User can click any device of the device matrix, therefore can transmit a network package of identification requirement to a plurality of PDEs. Thus, user can perform an intuitional management and an intuitional operation.

Fifth advantages of the invention is, the PDE of the invention has a plurality of through holes, each outlet indicator light of each outlet is located on an underside of each through hole, an upside of each through hole can dispose a light guiding element to enhance an effect of outlet identification.

The above and other objects, features and advantages of the invention will become apparent from the following detailed description taken with the accompanying drawings.

### BRIEF DESCRIPTION OF THE DRAWINGS

FIG. 1 is a perspective view showing a PDE (power distribution equipment) of a first embodiment of the invention;

FIG. 1A is a functional block diagram illustrating the PDE of the first embodiment of the invention;

FIG. 1B is a perspective view showing power apparatus of the first embodiment of the invention;

FIG. 1C is a flowchart illustrating an outlet identification method of the first embodiment of the invention;

FIG. 1D is a diagram illustrating a user interface of the first embodiment of the invention;

FIG. 1E is another functional block diagram illustrating the PDE of the first embodiment of the invention;

FIG. 2 is a diagram illustrating a user interface of a second embodiment of the invention;

FIG. 3 is a diagram illustrating a user interface of a third embodiment of the invention;

FIG. 4 is a perspective view showing a PDE of a fourth embodiment of the invention;

FIG. 5 is a perspective view showing a PDE of a fifth embodiment of the invention;

FIG. 5A is a functional block diagram illustrating the PDE of the fifth embodiment of the invention;

FIG. 5B is a diagram illustrating a user interface of the fifth embodiment of the invention;

FIG. 5C is another functional block diagram illustrating the PDE of the fifth embodiment of the invention;

FIG. 6 is a perspective view showing a PDE of a sixth embodiment of the invention;

FIG. 7 is a perspective view showing a PDE of a seventh embodiment of the invention;

FIG. 7A is a exploded view showing the PDE of the seventh embodiment of the invention;

FIG. 8 is a perspective view showing a PDE of a eighth embodiment of the invention;

FIG. 8A is a exploded view showing the PDE of the eighth embodiment of the invention;

FIG. 9 is a perspective view showing a first plug-in manner of powered devices of a ninth embodiment of the invention;

FIG. 9A is a perspective view showing a second plug-in manner of powered devices of the ninth embodiment of the invention;

FIG. 9B is a perspective view showing a third plug-in manner of powered devices of the ninth embodiment of the invention.

### DETAILED DESCRIPTION OF THE INVENTION

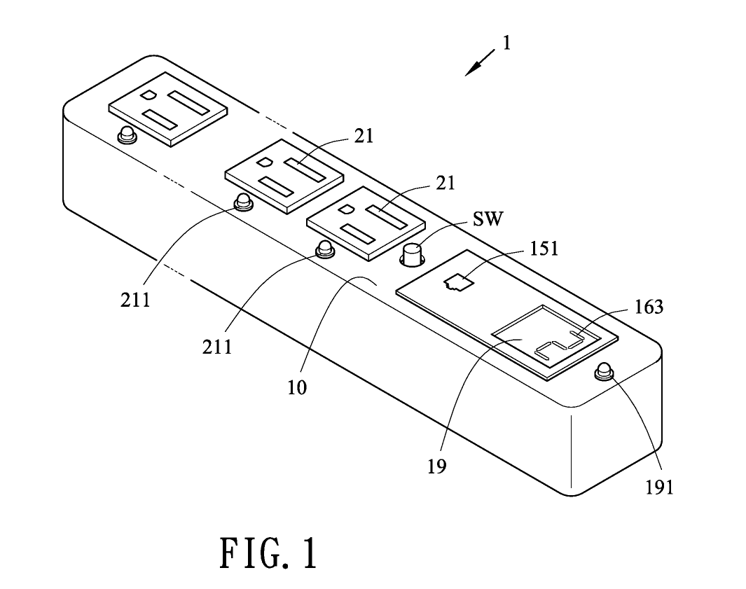

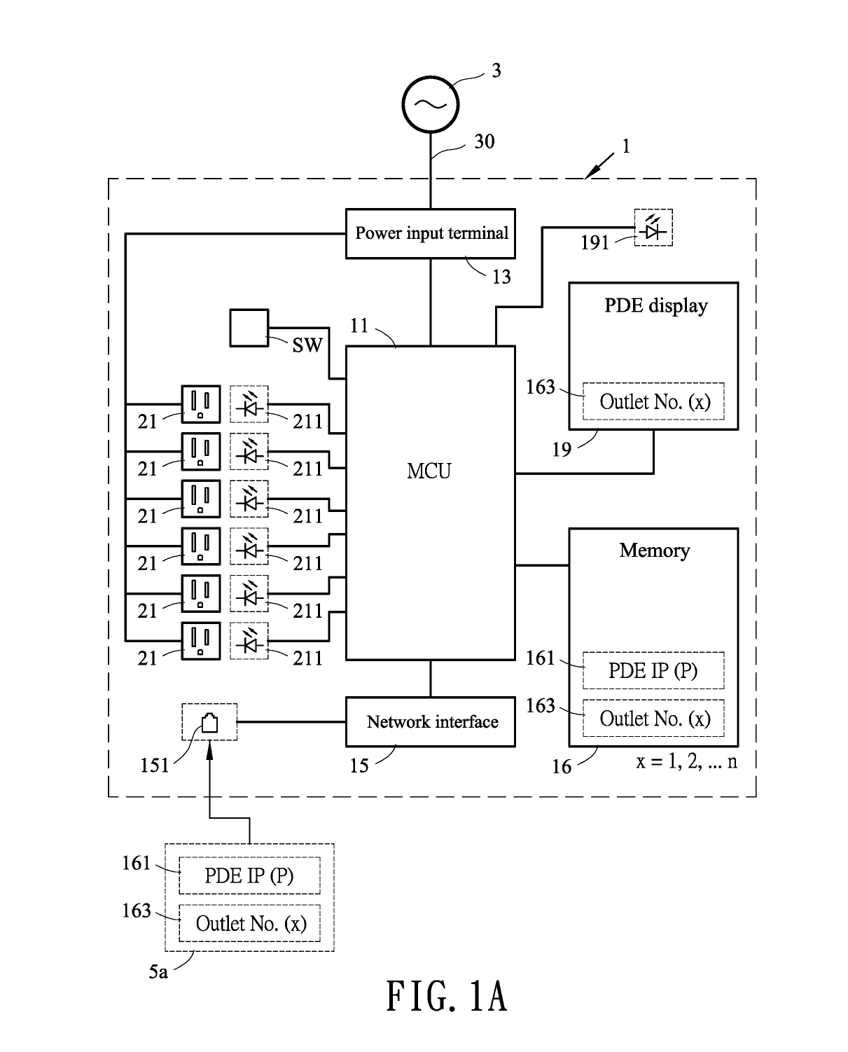

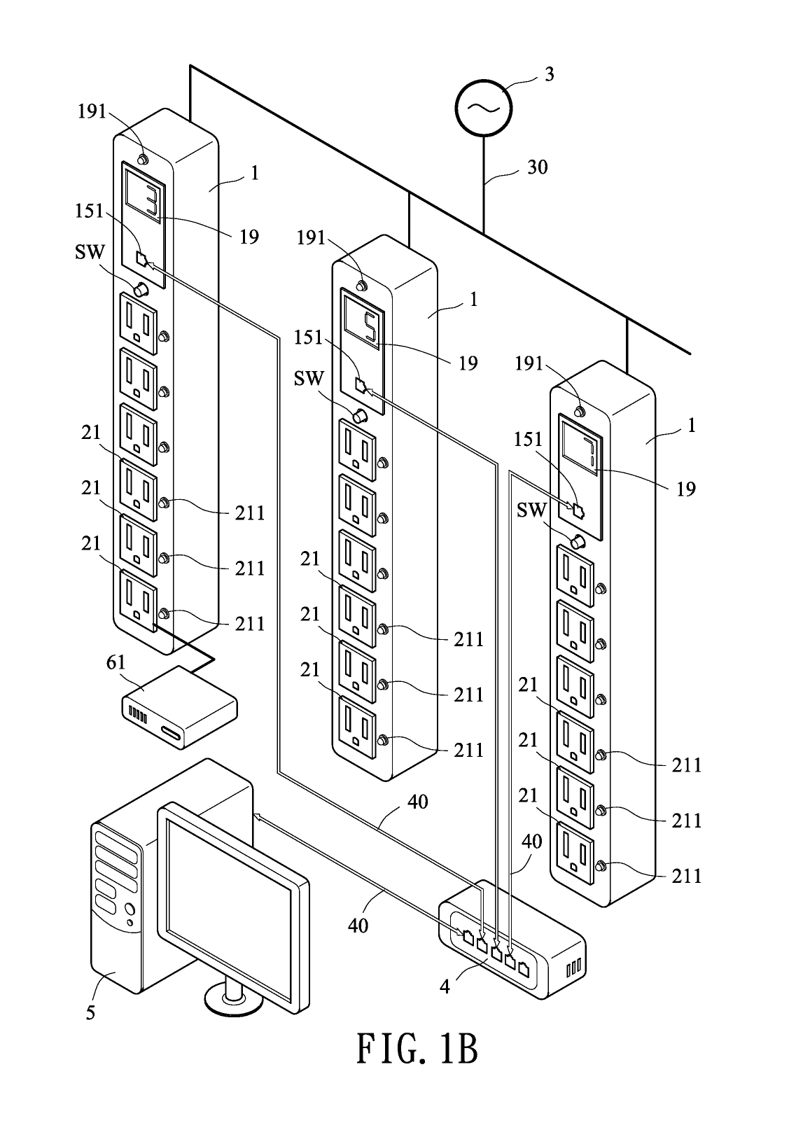

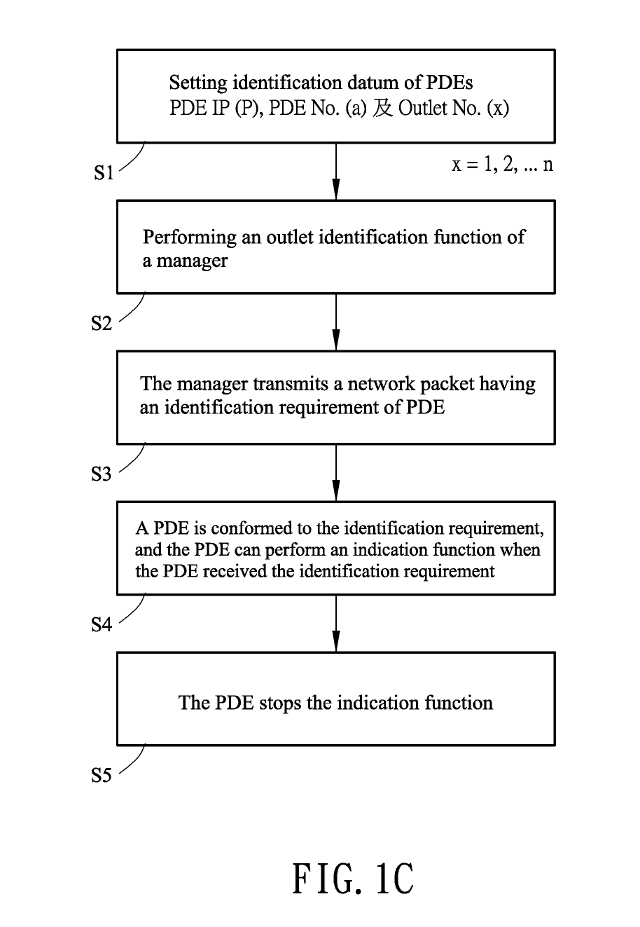

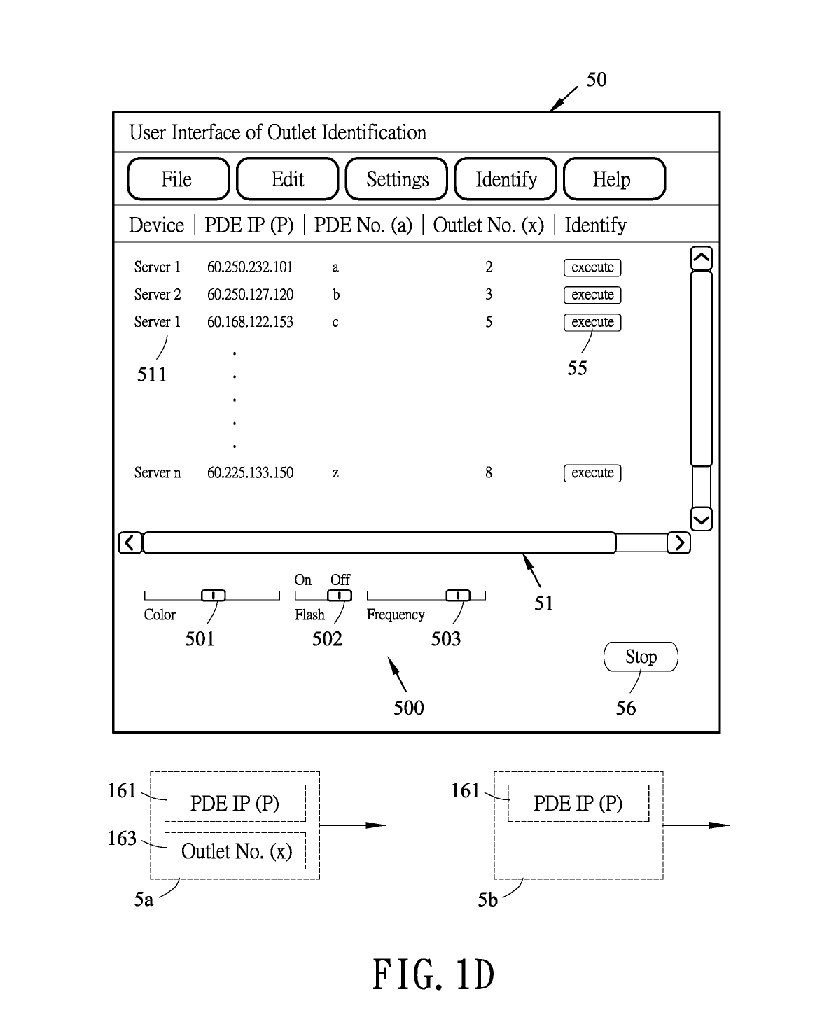

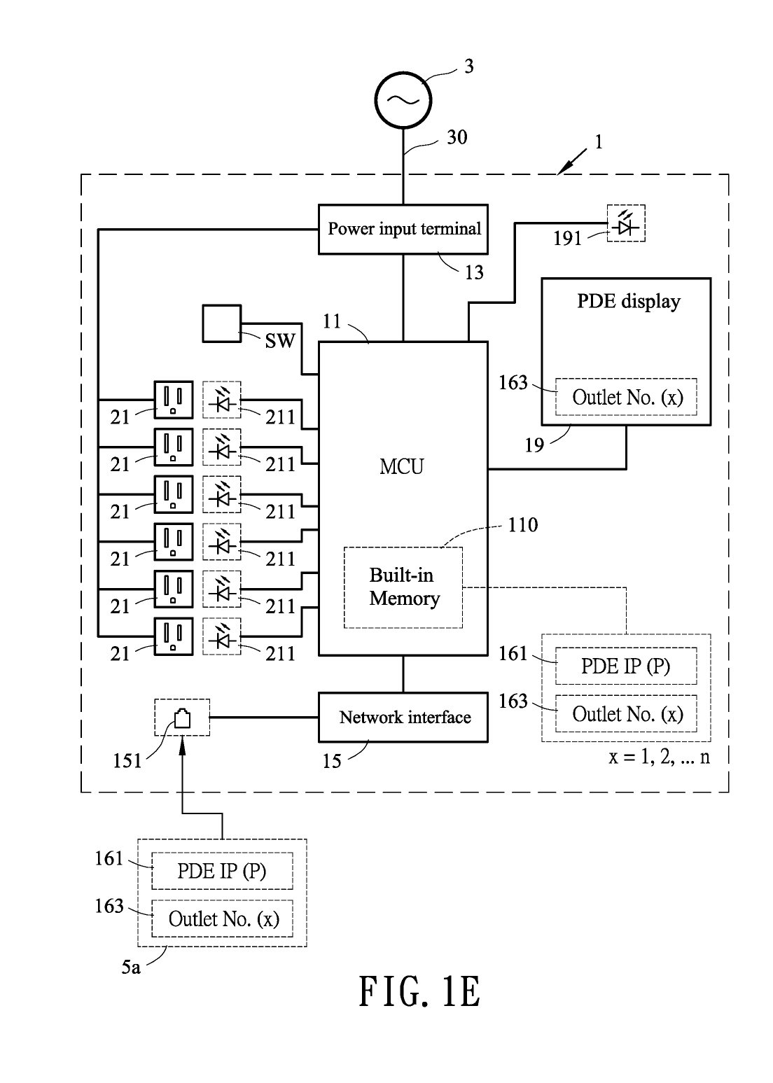

Referring to FIGS. 1 to 1B, power apparatus in accordance with a first embodiment of the invention has a PDE (power distribution equipment) 1, the PDE comprises a processor unit 11, a power input terminal 13, a memory 16 and a plurality of outlets 21; the power input terminal 13 can be connected to a power source 3 by a power line 30, the outlets 21 can distribute input power of the power source 3, the outlets 21 is connected to the power input terminal 13, the processor unit 11 can process an identification requirement 5a, the processor unit 11 connected with a network interface unit 15, the processor unit 11 can receive the identification requirement 5a via the network interface unit 15, the memory 16 can save an identification data, the memory 16 is connected to the processor unit 11; wherein the identification data has at least one IP (internet protocol) address 161 and outlet codes 163 of the outlets 21, the identification requirement 5a has the IP address 161 and at least one outlet code 163, the processor unit 11 can driver at least one outlet indicator light 211 to radiate according to the identification requirement 5a, or driver at least one PDE display 19 to show the outlet code 163 according to the identification requirement 5a. Thus, user does not need to memorize IP address 161 and outlet code 163 of powered device 61, and user can quickly find out a correct plug-in position of powered device 61, therefore can make a replacement, a repair or a test for powered device 61.

Examples of the executing manner of the outlet indicator light 211, each outlet indicator light 211 has a corresponding outlet code 163 of at least one outlet indicator light 211; wherein each outlet indicator light 211 is located on a top surface 10 of the PDE 1, each outlet indicator light 211 can be selected from LED (light emitting diode) lamp or a small lamp, each outlet code 163 can be selected from a character code, a numeral code, a mixing code of numeral and character, an array number, such as Outlet No. (x) , the value x is in a range from 1 to N.

Examples of the executing manner of the network interface unit 15, the network interface unit 15 can be selected from an Ethernet network interface or an optical fiber network interface; wherein the network interface unit 15 has at least one network port 151; wherein the network port 151 can be selected from a RJ45 network socket or an optical fiber network socket; when the power apparatus of the invention has a plurality of PDE 1, the power apparatus can use a network Hub 4 and a plurality of network cable 40 to connect the network interface units 15 of the PDEs 1 and a manager 5, the manager 5 can be selected from a server computer, a personal computer, a notebook computer, a tablet computer or an all-in-one computer.

Examples of an identification manner of the PDEs 1, each top surface 10 of each PDE 1 further a PDE indicator light 191; wherein at least one processor unit 11 of PDE 1 can driver at least one PDE indicator light 191 to radiate according to the IP address 161 of the identification requirement 5a, the PDE indicator light 191 can be selected from LED lamp or a small lamp.

Examples of a stopping manner of the PDEs 1 identification, each PDE 1 has at least one switch SW, therefore can stop the radiation of the outlet indicator light 211 and the PDE indicator light 191, the switch SW can be selected from a rocker switch, a push switch, a toggle switch, a DIP switch or a touch switch.

Referring to FIGS. 1A to 1D, an outlet identification method of power apparatus in accordance with the first embodiment of the invention comprises a step S1, setting identification datum of a plurality of PDEs 1, each identification data has an IP address 161 and a plurality of outlet codes 163; a step S2, performing an outlet identification function of a manager 5, the manager 5 has a user interface 50, the PDEs 1 and the manager 5 can be connected to become a network; a step S3, the manager 5 transmits a network packet, the network packet has an identification requirement 5a, the identification requirement 5a has at least one IP address 161 and at least one outlet code 163; a step S4, at least one IP address 161 of PDE 1 is conformed to the IP address 161 of identification requirement 5a, and the conformed PDE 1 can perform an indication function according to the outlet code 163 of identification requirement 5a, wherein the indication function is defined as that at least one outlet indicator light 211 can be driven to radiate, or at least one PDE display 19 can be driven to show the outlet code 163 of identification requirement 5a; therefore a plug-in position of at least one powered device 61 can be identified by performing the step S2 to the step S4.

Examples of the executing manner of the user interface 50, the user interface 50 has a data form 51, the data form 51 has a device field, an IP address field and an outlet code field; wherein each data 511 has an executing key 55, user can click any executing key 55 to transform the data 511 to an identification requirement 5a, and the manager 5 will transmit the identification requirement 5a to a plurality of PDEs 1 by a network packet manner.

Examples of a stopping manner of the indication function, the outlet identification method of the invention further comprises a step S5, the manager 5 can perform a function of stopping indication; wherein the user interface 50 has a stop key 56, user can click the stop key 56 to transmit a network packet of stopping requirement 5b to the PDEs 1, the stopping requirement 5b has at least one IP address 161, at least one IP address 161 of PDE 1 is conformed to the IP address 161 of stopping requirement 5b, and the conformed PDE 1 will stop the indication function.

Examples of an adjustment manner of the indication function, the user interface 50 has at least one indication function adjustment option 500; wherein the indication function adjustment option 500 can be selected from a color adjustment option 501, a flash switch adjustment option 502 or a flash frequency adjustment option 503, therefore can quickly adjust a radiation mode of the outlet indicator lights 211 or a display mode of the PDE display 19 by a processor unit 11. Thus, an administrator can assign a replacement task, a repair task or a test task of each powered device 61, a repairman will correctly identify at apparatus site.

Referring to FIG. 1E, a processor unit 11 in accordance with the first embodiment can be a MCU (microcontroller unit); wherein the processor unit 11 can integrate with a built-in memory 110, therefore can save identification datum, for example, at least one IP address 161 and each outlet code 163 are saved to the built-in memory 110, and thereby simplify constituent of the PDE 1.

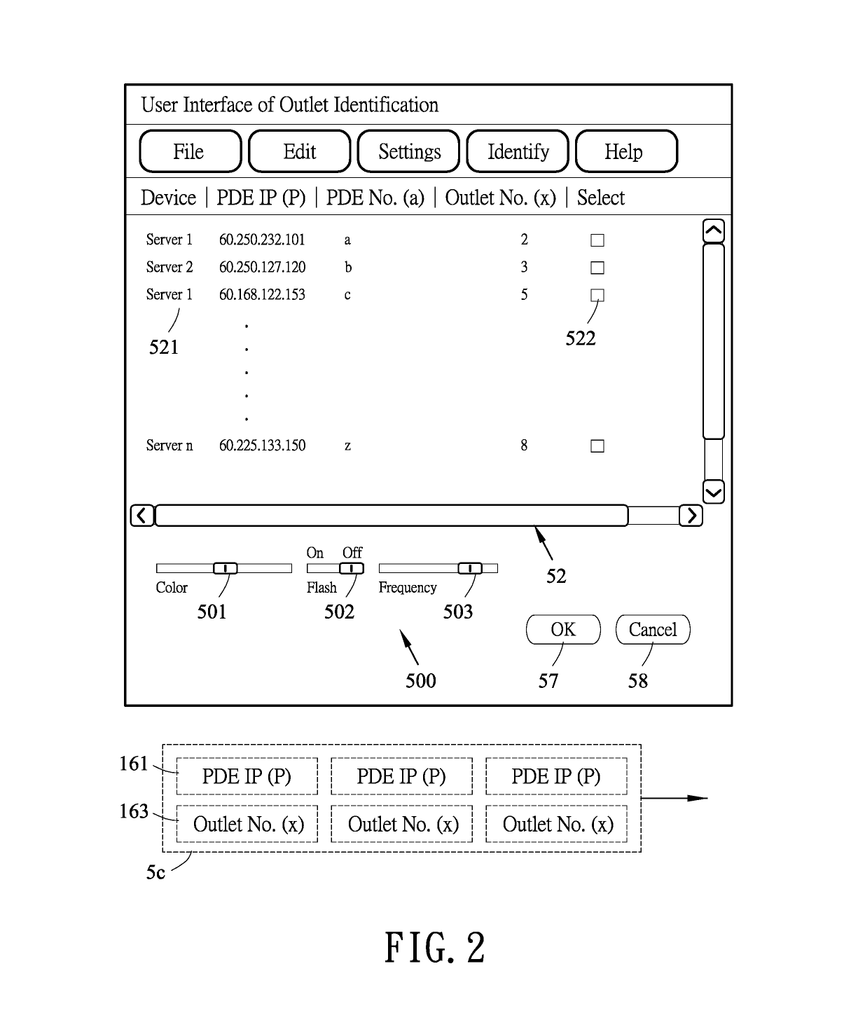

Referring to FIGS. 2 to 1B, a user interface 50 in accordance with a second embodiment has a data form 52, a confirming key 57 (e.g., OK key) and a cancel key 58; wherein the data form 52 has a device field, an IP address field, an outlet code field and a select field. Thus, user can select a plurality of datum 521 by a plurality of select field options 522, user can click the cancel key 58 to cancel any select field option 522, and user can click the confirming key 57 to transform a selected data 521 or a plurality of selected datum 521 to an identification requirement 5c, and the manager 5 will transmit the identification requirement 5c to a plurality of PDEs 1 by a network packet manner.

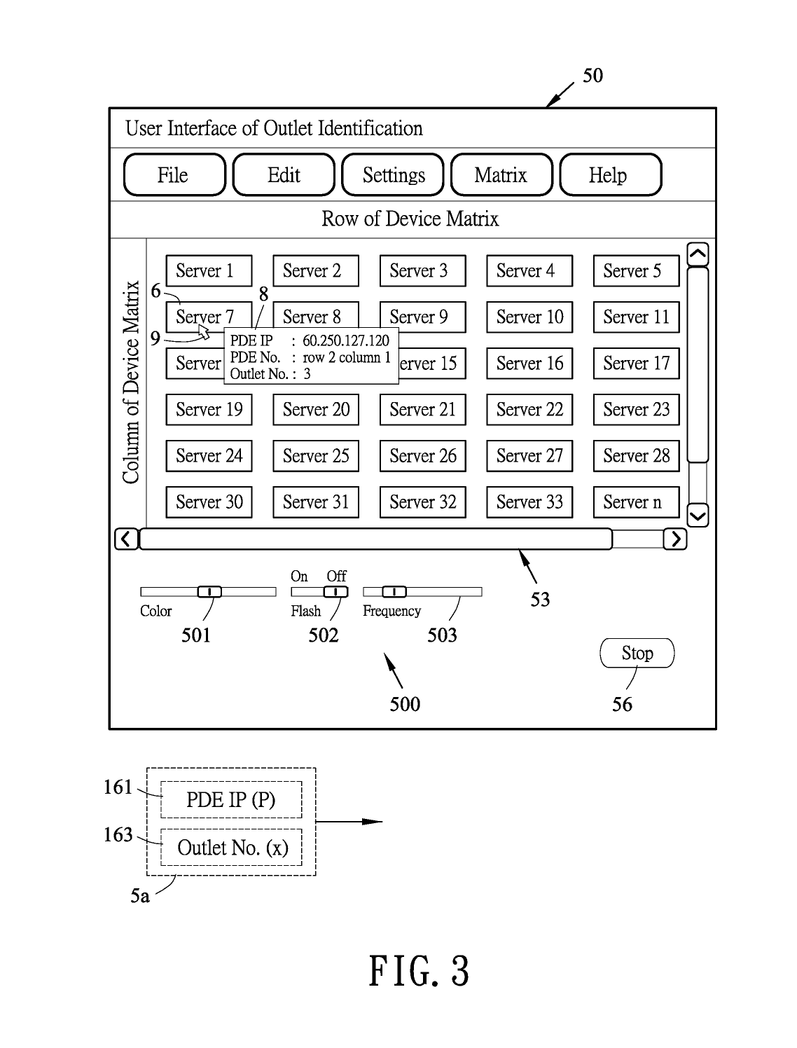

Referring to FIGS. 3 to 1B, a user interface 50 in accordance with a third embodiment has a device matrix 53, which arranged a plurality of devices 6 (e.g., server) by a matrix manner, for example, each device 6 has at least one corresponding description area 8, each description area 8 has at least one IP address and at least one outlet code, therefore can point out a plug-in position of each device 6; when a cursor 9 is moved to a device 6 of the device matrix 53, the user interface 50 can display a description area 8. Moreover, user can click any device 6 of the device matrix 53 to transmit a network package of identification requirement 5a to a plurality of PDEs 1. Thus, user can perform an intuitional management and an intuitional operation.

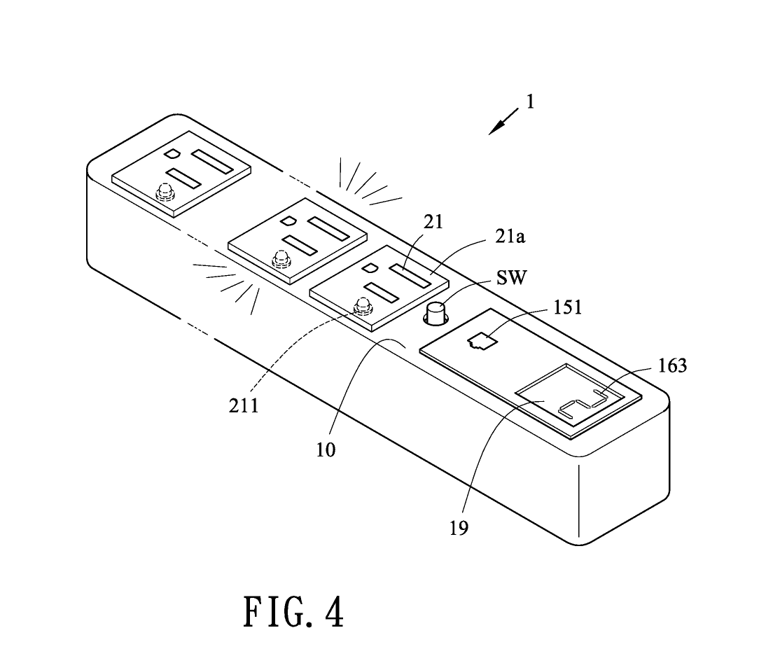

Referring to FIG. 4, each outlet indicator lights 211 in accordance with a fourth embodiment is located on an underside of each outlet panel 21a; wherein the outlet panels 21a can be selected from a transparent material, a translucent material or a light guiding material, therefore can protect the outlet indicator lights 211. Thus, a PDE 1 can be provided with an effect of outlet identification by radiation of the outlet panels 21a.

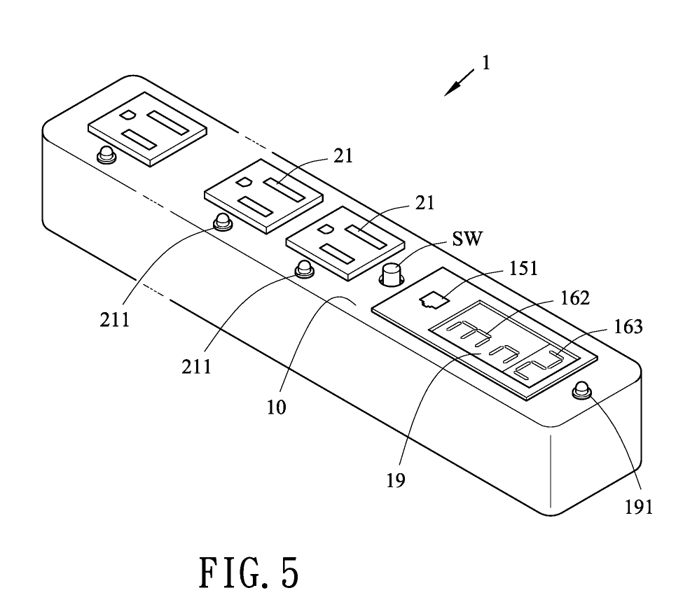

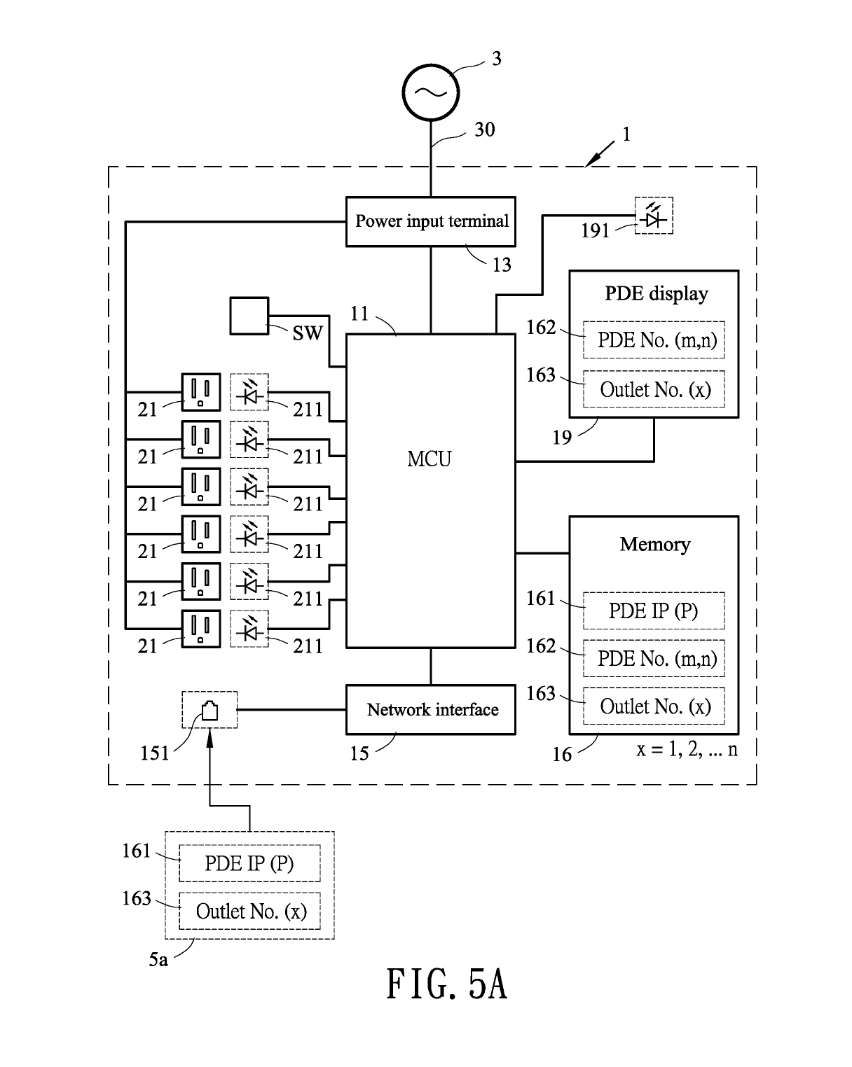

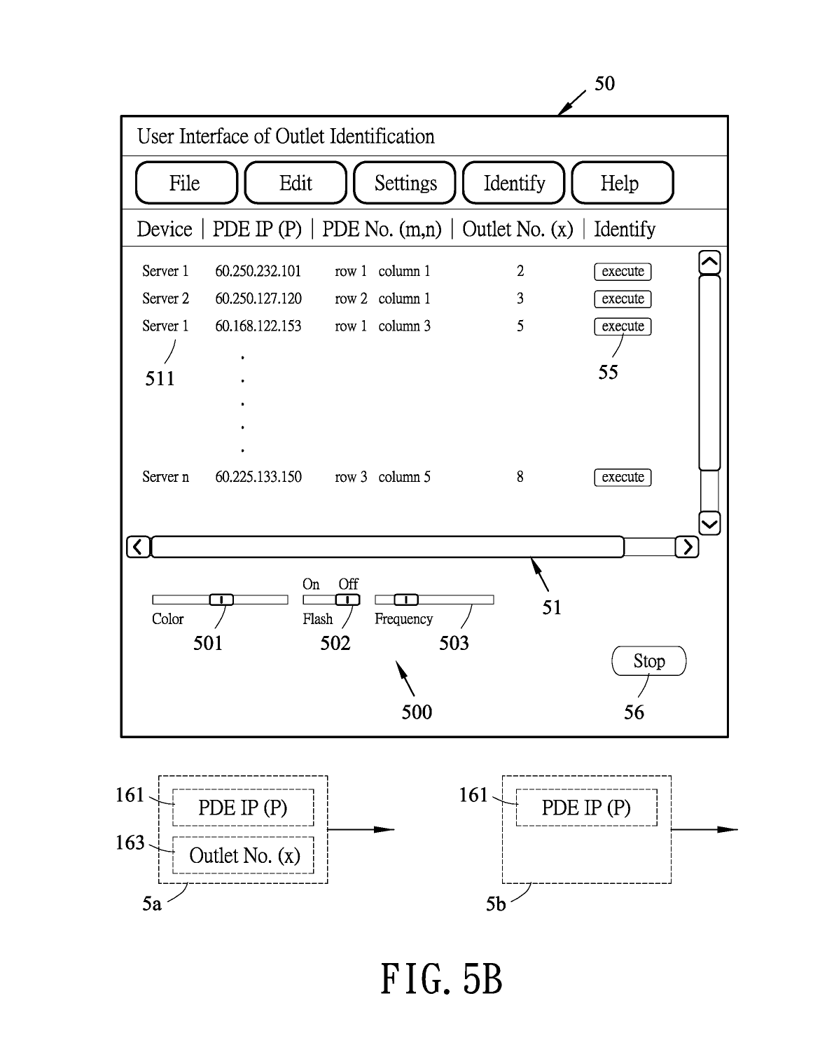

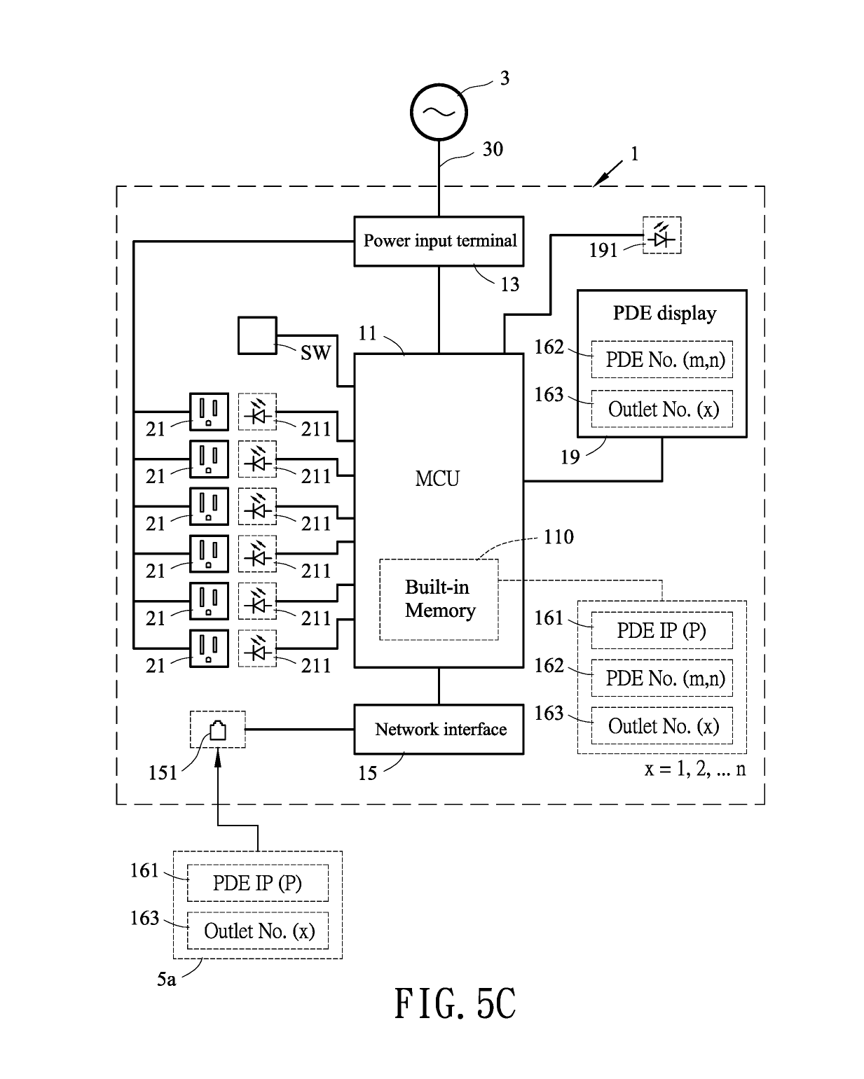

Referring to FIGS. 5 to 5B, identification datum of PDE 1 in accordance with a fifth embodiment has at least one IP address 161, a PDE number (PDE code) 162 and each outlet code 163; wherein a PDE 1 is conformed to an identification requirement 5a, and the PDE 1 can drive a PDE display 19 to show the PDE number 162 and the outlet code 163 of identification requirement 5a; the PDE number 162 can be selected from one-dimensional array value, two-dimensional arrays value or multi-dimensional arrays value, therefore a repairman will know a location of each PDE 1 at apparatus site. Moreover, a data form 51 of user interface 50 further has a PDE number field, therefore an administrator will know a distribution position of each PDE 1.

Referring to FIG. 5C, a processor unit 11 in accordance with the fifth embodiment can be a MCU (microcontroller unit); wherein the processor unit 11 can integrate with a built-in memory 110, therefore can save identification datum, for example, at least one IP address 161, a PDE number (PDE code) 162 and each outlet code 163 are saved to the built-in memory 110, and thereby simplify constituent of the PDE 1.

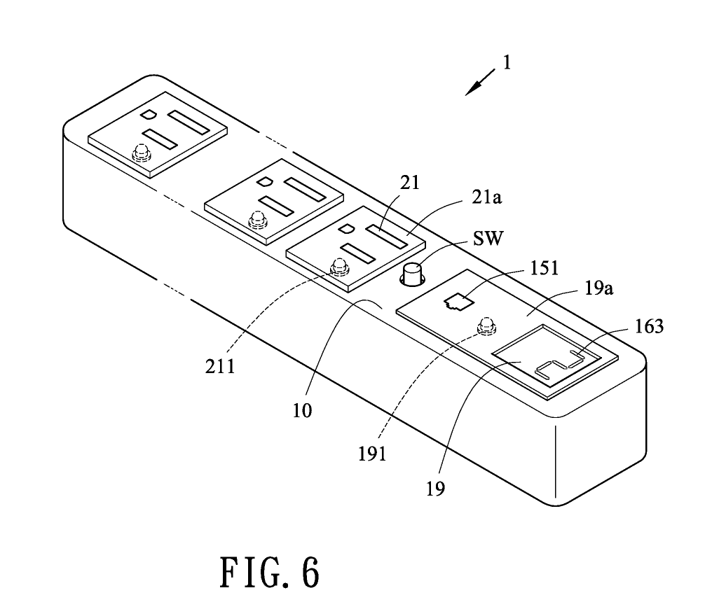

Referring to FIG. 6, a PDE indicator light 191 in accordance with a sixth embodiment is located on an underside of a PDE panel 19a; wherein the PDE panel 19a can be selected from a transparent material, a translucent material or a light guiding material, therefore can protect the PDE indicator light 191. Thus, a PDE 1 can enhance an effect of PDE identification by radiation of the PDE panel 19a.

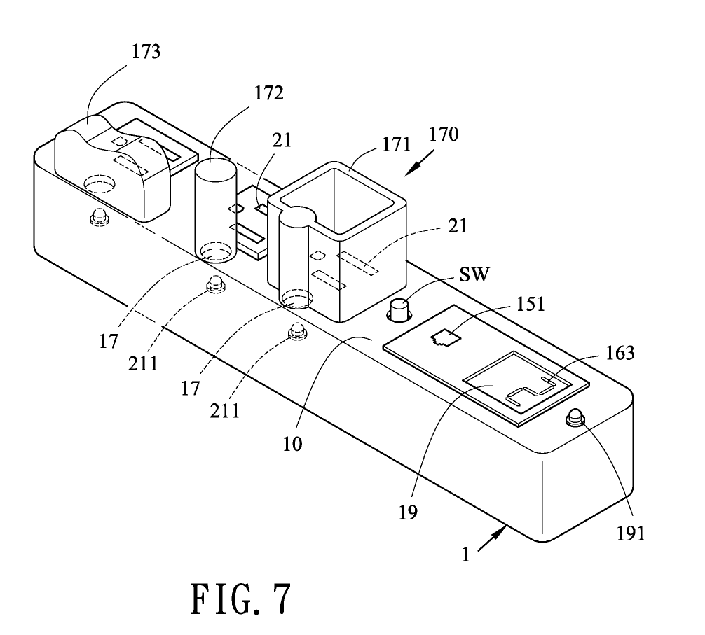

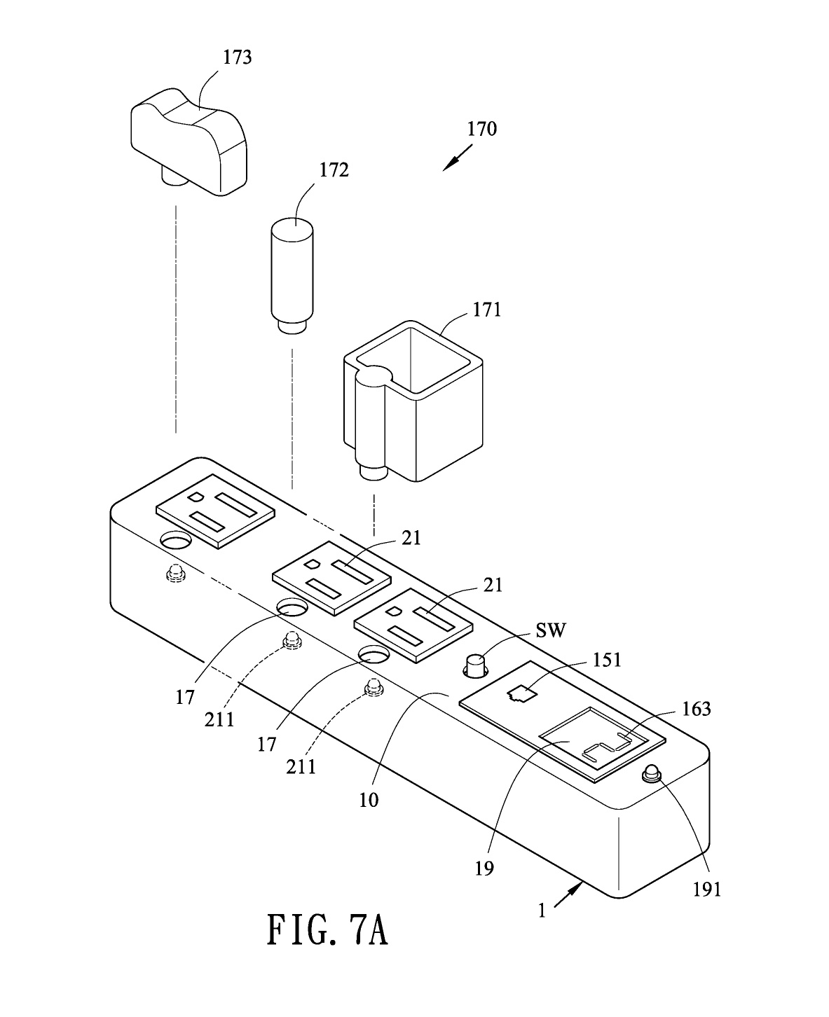

Referring to FIGS. 7 to 7A, a PDE 1 in accordance with a seventh embodiment has a plurality of through holes 17; wherein each outlet indicator light 211 is located on an underside of each through hole 17, an upside of each through hole 17 can dispose a light guiding element 170, the light guiding element 170 can be selected from a light guiding element 171 of rectangle frame, a light guiding element 172 of geometric shape or a light guiding element 173 of non-geometric shape. When a plurality of device power plugs (not shown) are individually plugged in a plurality of outlets 21, the device power plugs will be possible to block user sight, the light guiding element 170 is just to enhance an effect of outlet identification.

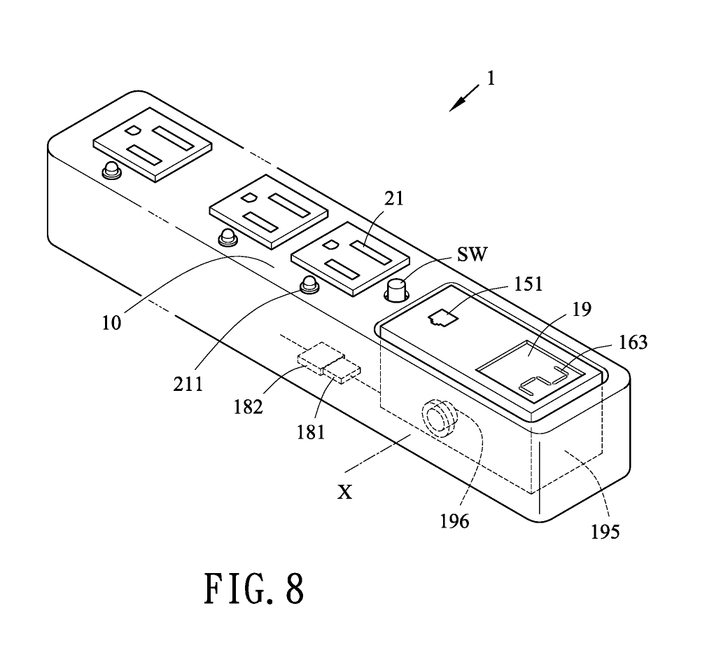

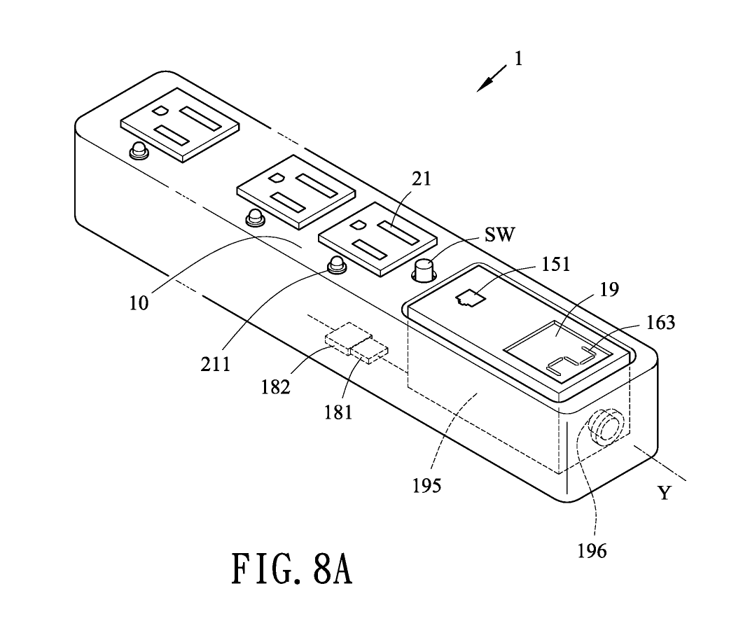

Referring to FIGS. 8 to 8A, a PDE display 19 of PDE 1 in accordance with an eighth embodiment is disposed at a control box 195; wherein the control box 195 uses a first connector 181 to electrically connect with a second connector 182 of PDE 1, the control box 195 can be replaced, therefore can quickly repair the PDE 1. Moreover, the control box 195 can be pivoted to the PDE 1, the PDE display 19 can adjust sight angle by the control box 195, a pivot direction of a pivot shaft 196 of control box 195 can be selected from a X axial direction of the PDE 1 (as shown in FIG. 8) or a Y axial direction of the PDE 1 (as shown in FIG. 8A).

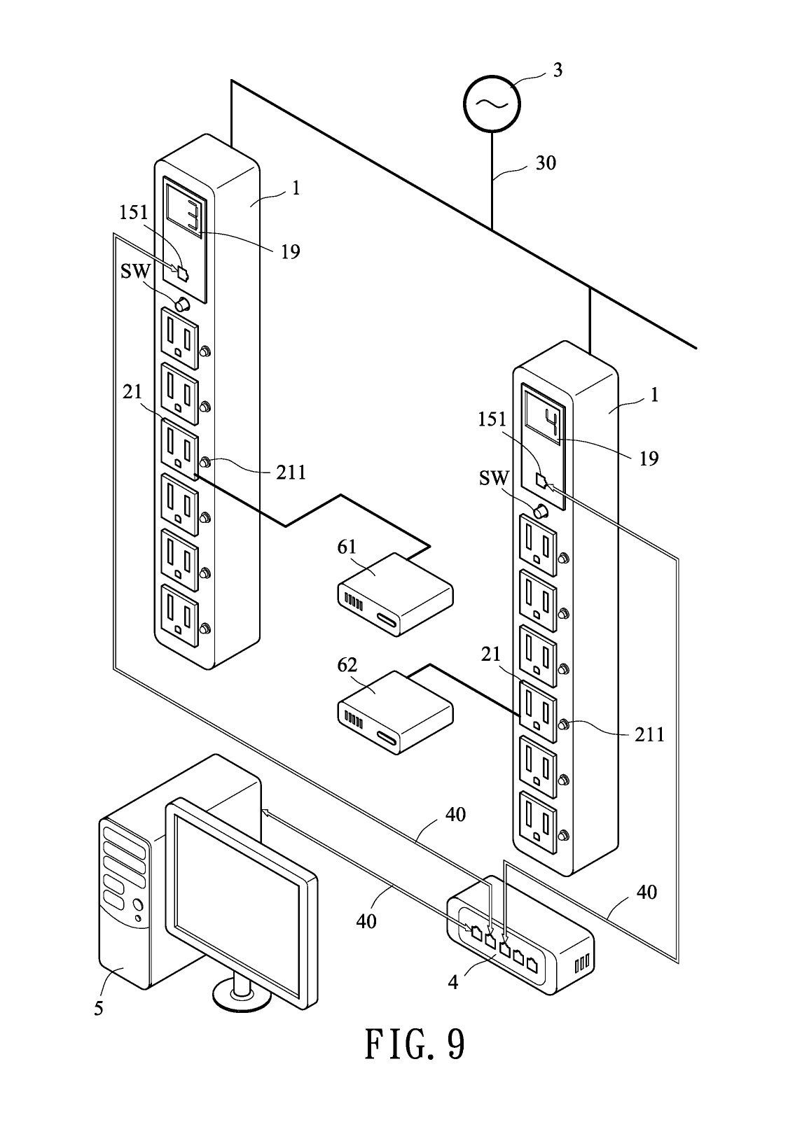

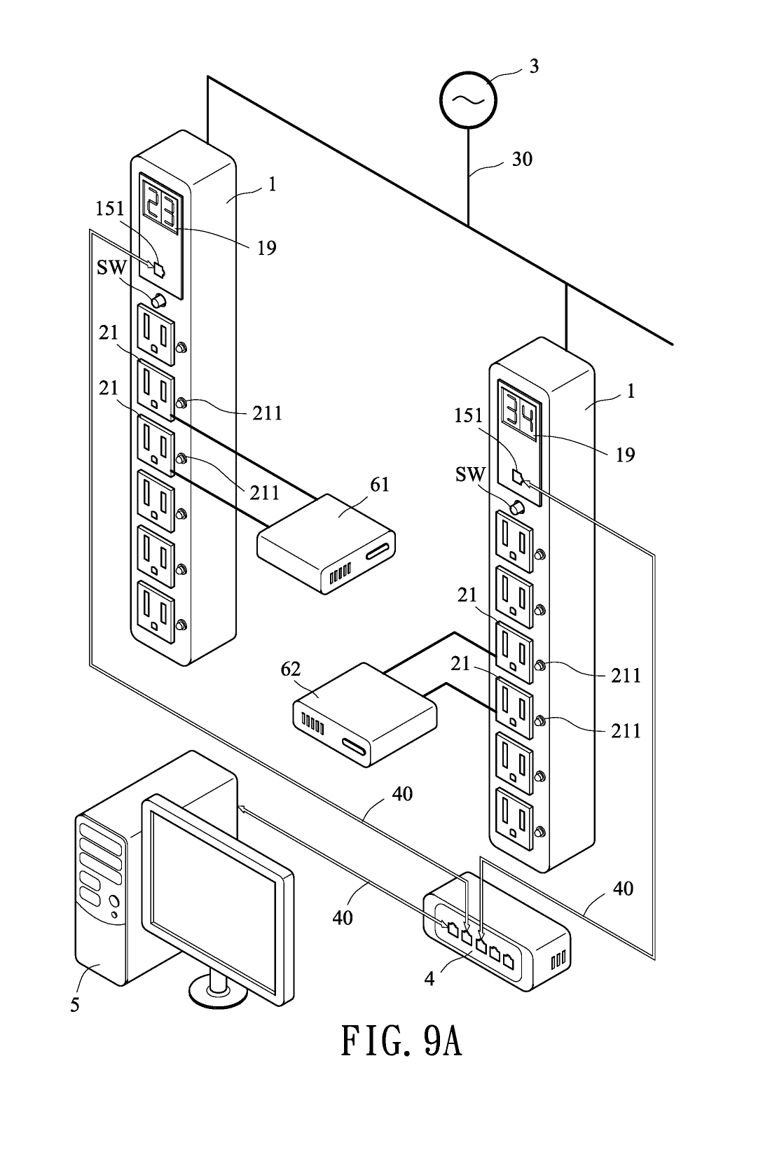

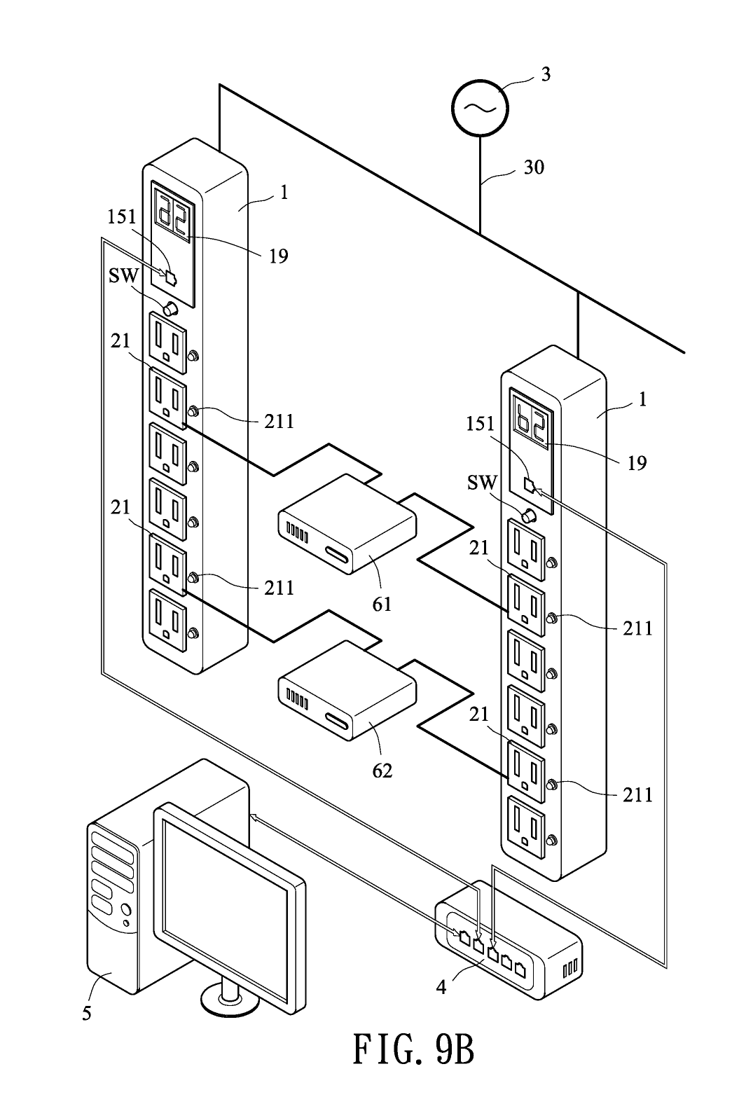

Referring to FIGS. 9 to 9B, plug-in positions of powered devices 61 can adopt a one-to-one manner or a one-to-two manner; wherein the one-to-one manner is defined as that a powered device 61 electrically connects to an outlet 21 of a PDE 1 (as shown in FIG. 9) , the one-to-two manner is defined as that a powered device 61 electrically connects to two outlets 21 of the same PDE 1 (as shown in FIG. 9A) , or the one-to-two manner is defined as that a powered device 61 electrically connects to two outlets 21 of the different PDEs 1 (as shown in FIG. 9B) . User does not need to inquire about an IP address and an outlet code of each powered device 61, and user can quickly find out a correct plug-in position of each powered device 61, therefore can make a replacement, a repair or a test for the powered devices 61, and prevent to imprudently break off the power of other devices 62.

What is claimed is:

1. A power apparatus with outlet identification capability, the power apparatus including at least one PDE (power distribution equipment), the PDE comprising:
a power input terminal used to connect to a power source;
a plurality of outlets used to distribute input power of the power input terminal;
a processor unit used to process an identification requirement, the processor unit connected with a network interface unit, the processor unit can receive the identification requirement via the network interface unit;
an identification data having an IP (internet protocol) address and an outlet code of each outlet; and
a plurality of outlet indicator light, each outlet code corresponded to at lease one outlet indicator light;
wherein the identification requirement has the IP address and at lease one the outlet code of the identification data, therefore the processor unit can driver at least one outlet indicator light to radiate according to the identification requirement.

2. The power apparatus with outlet identification capability of claim 1, wherein a storage position of the identification data can be selected from a memory unit or a built-in memory of the processor unit; the network interface unit can be selected from an Ethernet network interface or an optical fiber network interface, the network interface unit has at least one network port, the network port can be selected from a RJ45 network socket or an optical fiber network socket.

3. The power apparatus with outlet identification capability of claim 1, wherein a location of each outlet indicator light can be selected from a top surface of the PDE or an underside of each outlet panel; the above outlet indicator lights can be selected from a LED (light emitting diode) lamp or a small lamp, the above outlet panel can be selected from a transparent material, a translucent material or a light guiding material.

4. The power apparatus with outlet identification capability of claim 1, wherein a top surface of the PDE further disposed a PDE indicator light, the processor unit can driver the PDE indicator light to radiate according to the IP address of the identification requirement;
the PDE indicator light can be selected from a LED lamp or a small lamp.

5. The power apparatus with outlet identification capability of claim 1, wherein the PDE has at least one switch used to stop the radiation of the outlet indicator light and the PDE indicator light, the switch SW can be selected from a rocker switch, a push switch, a toggle switch, a DIP switch or a touch switch.

6. The power apparatus with outlet identification capability of claim 1, wherein the PDE has a plurality of through holes, each outlet indicator light is located on an underside of each through hole, a light guiding element is disposed at an upside of each through hole, the above light guiding element can be selected from a light guiding element of rectangle frame, a light guiding element of geometric shape or a light guiding element of non-geometric shape.

7. A power apparatus with outlet identification capability, the power apparatus including at least one PDE, the PDE comprising:
a power input terminal used to connect to a power source;
a plurality of outlets used to distribute input power of the power input terminal;
a processor unit used to process an identification requirement, the processor unit connected with a network interface unit, the processor unit can receive the identification requirement via the network interface unit;
an identification data having an IP address and an outlet code of each outlet; and
a PDE display electrically connected to the processor unit;
wherein the identification requirement has the IP address and at lease one the outlet code of the identification data, therefore the processor unit can driver the PDE display to show the outlet code of the identification requirement.

8. The power apparatus with outlet identification capability of claim 7, wherein a storage position of the identification data can be selected from a memory unit or a built-in memory of the processor unit; the network interface unit can be selected from an Ethernet network interface or an optical fiber network interface, the network interface unit has at least one network port, the network port can be selected from a RJ45 network socket or an optical fiber network socket.

9. The power apparatus with outlet identification capability of claim 7, wherein the identification data further has a PDE number (PDE code) , the processor unit can driver the PDE display to show the PDE number according to the identification requirement, the PDE number can be selected from one-dimensional array value, two-dimensional arrays value or multi-dimensional arrays value.

10. The power apparatus with outlet identification capability of claim 7, wherein the PDE further has a PDE panel, a PDE indicator light is located on an underside of a PDE panel, the processor unit can driver the PDE indicator light to radiate according to the identification requirement, the PDE indicator light can be selected from a LED lamp or a small lamp, the PDE panel can be selected from a transparent material, a translucent material or a light guiding material.

11. The power apparatus with outlet identification capability of claim 7, wherein the PDE display is disposed at a control box, the control box used a first connector to electrically connect with a second connector of the PDE, the control box can be replaced, therefore can quickly repair the PDE.

12. The power apparatus with outlet identification capability of claim 11, wherein the control box can be pivoted to the PDE, the PDE display can adjust sight angle by the control box, a pivot shaft direction of the control box can be selected from a X axial direction or a Y axial direction of the PDE.

13. An outlet identification method of power apparatus comprising the steps of:
S1) setting identification datum of a plurality of PDEs, each identification data has an IP address and a plurality of outlet codes;
S2) performing an outlet identification function of a manager, the manager has a user interface, the PDEs and the manager can be connected to become a network;
S3) transmitting a network packet by the manager, the network packet has an identification requirement, the identification requirement has at least one IP address and at least one outlet code;
S4) at least one IP address of PDE is conformed to the IP address of identification requirement, and the conformed PDE can perform an indication function according to the outlet code of identification requirement;
wherein the indication function is defined as that at least one outlet indicator light can be driven to radiate, or a PDE display can be driven to show the outlet code of identification requirement, therefore a plug-in position of at least one powered device can be identified.

14. The outlet identification method of power apparatus of claim 13, wherein the user interface has a data form, the data form has a device field, an IP address field and an outlet code field; each data has an executing key, user can click any executing key to transform the data to an identification requirement, and the manager will transmit the identification requirement to a plurality of PDEs by a network packet manner.

15. The outlet identification method of power apparatus of claim 13, wherein the method further comprises the steps of:
S5) performing a function of stopping indication by the manager, the user interface has a stop key, user can click the stop key to transmit a network packet of stopping requirement to the PDEs, the stopping requirement has at least one IP address, at least one IP address of PDE is conformed to the IP address of stopping requirement, and the conformed PDE will stop the indication function.

16. The outlet identification method of power apparatus of claim 13, wherein the user interface has at least one indication function adjustment option, the indication function adjustment option can be selected from a color adjustment option, a flash switch adjustment option or a flash frequency adjustment option, therefore can quickly adjust a radiation mode of the outlet indicator lights or a display mode of the PDE display.

17. The outlet identification method of power apparatus of claim 13, wherein the user interface has a data form, a confirming key and a cancel key; the data form has a device field, an IP address field, an outlet code field and a select field, user can select a data or a plurality of datum by a plurality of select field options, user can click the cancel key to cancel any select field option, and user can click the confirming key to transform the selected data or a plurality of selected datum to an identification requirement, and the manager will transmit the identification requirement to a plurality of PDEs by a network packet manner.

18. The outlet identification method of power apparatus of claim 13, wherein the user interface has a device matrix, each device has at least one corresponding description area, each description area has at least one IP address and at least one outlet code, when a cursor is moved to a device of the device matrix, the user interface can display a description area, user can click any device of the device matrix to transmit a network package of identification requirement to a plurality of PDEs.

19. The outlet identification method of power apparatus of claim 13, wherein the user interface has a data form, the data form has a device field, an IP address field, a PDE number (PDE code) field and an outlet code field; each identification data has a PDE number, the indication function includes that each PDE display can be driven to show each PDE number, the PDE numbers can be selected from one-dimensional array value, two-dimensional arrays value or multi-dimensional arrays value.

20. The outlet identification method of power apparatus of claim 13, wherein plug-in positions of powered devices can adopt a one-to-one manner or a one-to-two manner; the one-to-one manner is defined as that a powered device electrically connects to an outlet of a PDE, the one-to-two manner is defined as that a powered device electrically connects to two outlets of the same PDE, or the one-to-two manner is defined as that a powered device electrically connects to two outlets of the different PDEs.
